(19) United States
(12) Patent Application Publication
(10) Pub. No.: US 2005/0106973 A1
(43) Pub. Date: May 19, 2005

(54) High tenacity and toughness in metallocene polypropylene films

(76) Inventors: Carolyn L. Sheldon, Cypress, TX (US); Mike Musgrave, Houston, TX (US); Peter Selg, Masnuy-St-Pierre (BE); Rodney Cummings, Dalton, GA (US)

Correspondence Address: FINA TECHNOLOGY INC, PO BOX 674412, HOUSTON, TX, 77267-4412, US

(21) Appl. No.: 10/713,811

(22) Filed: Nov. 14, 2003

(51) Int. Cl. D03D 15/00; B28B 1/00

(52) U.S. Cl. 442/185; 264/650; 442/186

(57) ABSTRACT

A film product and a method of making the same are provided, the film product comprising a metallocene catalyzed polypropylene and a tenacity of at least about 2.5 g/den is provided. The film product is capable of being drawn at a draw ratio of from about 5.0:1 to about 10.0:1. The film product is also capable of being processed into a slit tape product. A method of weaving a woven product from the slit tape product is also provided, wherein the woven product may have a tenacity within about 10.0 percent of the tenacity of the film product.

### BACKGROUND OF THE INVENTION

1. Field of the Invention

This invention relates to the field of polymers and more specifically to the field of film products comprising metallocene catalyzed polypropylene.

2. Background of the Invention

Polypropylene is typically produced in continuous polymerization reactors that may include loop reactors. A monomer stream may be introduced into the loop reactor and then circulated with an appropriate catalyst to produce the polypropylene. Ziegler-Natta catalysts have been the conventional catalysts used to produce polypropylene by polymerization. After polymerization, the polypropylene may typically be withdrawn from the reactor in powder or granular form. The granular polymer may then be subjected to appropriate purification and processing steps. After such steps, the polymer may be extruded in a melted state through an extruder and die mechanism to convert the polymer to a film or other product. Such film products may then be used to produce end-use products such as slit tapes, woven fabrics, and the like.

The conventional processes for producing such end-use products, for instance woven fabrics, may include exposing the film products to high stress operations such that the end-use products have reduced strength and toughness properties. Therefore, there is a need for a film product that comprises high strength and toughness properties. A further need exists for a film product that substantially retains its strength and toughness properties after exposure to the high stress operations used to convert it to a desired end use product.

### BRIEF SUMMARY OF SOME OF THE PREFERRED EMBODIMENTS

One embodiment of the present invention is a film product comprising a metallocene catalyzed polypropylene, and a tenacity of at least about 2.5 g/den, wherein the film product is capable of being drawn at a draw ratio of from about 5.0:1 to about 10.0:1. The film product can further have a tenacity of about 5.0 g/den and capable of being processed into at least one of a slit tape and a woven product. The film product and/or the slit tape product can be capable of being woven into a woven product. The metallocene catalyzed polypropylene can be a metallocene catalyzed isotactic polypropylene.

Another embodiment of the invention can be a film product of a process comprising: polymerizing a monomer in the presence of a metallocene catalyst system to produce metallocene catalyzed polypropylene, wherein the metallocene catalyst system comprises a metallocene catalyst; processing the metallocene catalyzed polypropylene into a film product; and drawing the film product at a draw ratio of from about 5.0:1 to about 10.0:1, the film product comprising a tenacity of at least about 2.5 g/den. The monomer can bed a propylene and the metallocene catalyst system can include a co-catalyst, such as an organoaluminum compound. The metallocene catalyst system can include at least one of a homogenous catalyst system and a supported catalyst system. The polymerizing of the monomer can be performed in a loop reactor system. The process can further include extruding the metallocene catalyzed polypropylene and drawing the metallocene catalyzed polypropylene through a die. The process can further include processing the film product into a slit tape product, such as by slitting the film product and/or weaving the slit tape product into a fabric and/or weaving the film product into a fabric. The film product can be a metallocene catalyzed isotactic polypropylene, such as having an isotacticity of less than about 99.0 percent.

Yet another embodiment of the invention is a method of producing a metallocene catalyzed polypropylene film product having a tenacity of at least about 2.5 g/den, the method comprising: extruding a metallocene catalyzed polypropylene, forming the metallocene catalyzed polypropylene into a substantially flat product, cooling the substantially flat product, and stretching the substantially flat product into the metallocene catalyzed polypropylene film product. The formation can include using a die to form the substantially flat product. The cooling can include cooling the substantially flat product with cooling equipment, the cooling equipment selected from the group consisting of: (i) at least one chill roller; and (ii) at least one quench bath. The at least one chill roller can cool the substantially flat product to a temperature of from about 30 degrees centigrade to about 60 degrees centigrade. The stretching can further include: (i) heating the substantially flat product; (ii) drawing the substantially flat product; and (iii) annealing the substantially flat product. The heating can further include heating the substantially flat product to a temperature of from about 130 degrees centigrade to about 180 degrees centigrade. The drawing can further include drawing the substantially flat product at a draw ratio of from about 5.0:1 to about 10.0:1. The annealing can further include heating the substantially flat product to a temperature of from about 130 degrees centigrade to about 170 degrees centigrade. The method can further include processing the film product into a slit tape product, weaving the slit tape product into a woven product, and weaving the film product into a woven product.

A further embodiment of the invention is a method of weaving a woven product from a slit tape having a tenacity of at least about 2.5 g/den, wherein the slit tape comprises a processed metallocene catalyzed polypropylene film product, the method comprising: supplying the slit tape to a loom, the slit tape being configured to be stored in a loom beam; and weaving the slit tape into the woven product, the woven product having a tenacity of within about 10.0 percent of the tenacity of the slit tape. The method can include the weaving a plurality of fill yarns into the woven product. The woven product can have a tenacity of within about 10.0 percent of the tenacity of the metallocene catalyzed polypropylene film product.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a process for the production of a polypropylene resin and a film product;

FIG. 2 illustrates a process for the production of a film product and a slit tape;

FIG. 3 illustrates a process for the production of a film product and a slit tape; and

FIG. 4 illustrates a process for the production of a woven product.

### DETAILED DESCRIPTION OF THE PREFERRED EMBODIMENTS

### I. POLYPROPYLENE POLYMERIZATION AND THE FILM PRODUCT

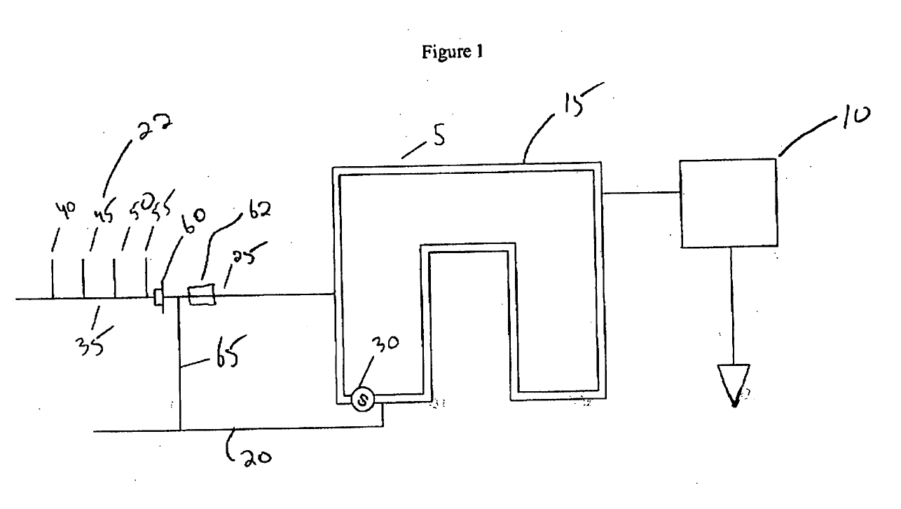

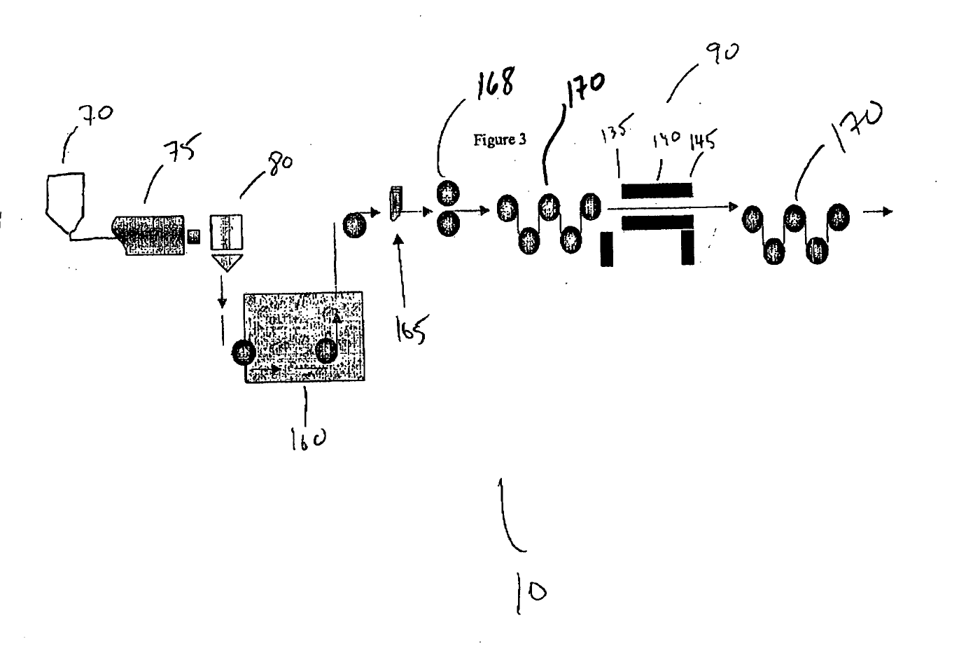

FIG. 1 illustrates a process for the production of a polypropylene resin and a film product. The polypropylene resin is produced by polymerization in a reactor system 5 using a metallocene catalyst. The polypropylene resin is then processed in a film processing unit 10 to produce the film product. The film product produced by the polypropylene of this reactor system 5 may have high strength and toughness properties. For instance, the film product, when slit as in the process described by FIG. 3, may exhibit a tenacity of about 5.0 g/den (ASTM D-3218). Alternatively, the tenacity may be at least about 2.5 g/den. The film product is capable of being drawn at a draw ratio of about 9.25:1. Alternatively, the film product may exhibit a draw ratio of about 5.0:1 to about 10.0:1. The film product may be drawn at a draw speed of from about 250 feet per minute to about 1000 feet per minute. In addition, the film product, when slit as per FIG. 3, may exhibit a measured elongation of from about 10% to about 50% (ASTM D-882). Moreover, the film product may comprise a measured 5% secant modulus of from about 10 grams per denier to about 50 grams per denier (ASTM D-882). Slit film products typical for this discussion may be of a denier of from about 500 to about 2000 grams per 9000 meters. The film product may also substantially retain its strength and toughness properties after being subjected to stressful end-use processing, such as the below-described weaving process. For instance, a typical woven product produced from the film product may comprise a tenacity of about 4.8 g/den. Alternatively, the typical woven product may comprise a tenacity of within about 10.0 percent of the tenacity of the film product. Alternatively, the typical woven product may comprise a tenacity of within about 4.0 percent of the tenacity of the film product.

As seen in FIG. 1, the reactor system 5 comprises a loop reactor 15, a propylene supply line 20, and a prepolymerization system 22 having a catalyst system input line 25. The loop reactor 15 may have an impeller 30. The impeller 30 may be rotatable and may be disposed to circulate a polymerization reaction mass continuously through the loop reactor 15. The loop reactor 15 may be configured to operate under controlled temperature and pressure conditions. The propylene supply line 20 may be connected to the loop reactor 15. In addition, the propylene supply line 20 may be disposed to supply propylene to the loop reactor 15. The catalyst system input line 25 may be connected to the loop reactor 15. The catalyst system input line 25 may be configured to supply a metallocene catalyst system to the loop reactor 15.

The following describes an exemplary application of the reactor system 5 as illustrated on FIG. 1. The catalyst system input line 25 supplies the metallocene catalyst system to the loop reactor 15. In the prepolymerization system 22, a carrier solvent supply line 40 may supply a carrier solvent to a catalyst mixing line 35. Carrier solvents are well known in the art, and examples of suitable carrier solvents may comprise hexane, heptane, propane, propene, and the like. A co-catalyst supply line 45 may supply a co-catalyst to the catalyst mixing line 35. An electron donor line 50 may also supply an electron donor to the catalyst mixing line 35. Electron donors are well known in the art and may include amines, amides, ethers, ketones, nitrites, phosphines, stibines, arsines, phosphoramides, thioethers, thioesters, aldehydes, alcoholates, salts of organic acids, and the like. A metallocene catalyst input line 55 may then supply a metallocene catalyst to the catalyst mixing line 35 to form a metallocene catalyst system. The metallocene catalyst may comprise supported catalysts. Alternatively, the metallocene catalyst may comprise at least one of homogenous catalysts and a mixture of supported catalysts and homogenous catalysts. A mixer 60 may then mix the metallocene catalyst system. Examples of available mixers are well known in the art and may comprise any suitable mixer for in-line mixing of catalyst systems. A prepolymerization line 65 may then expose the metallocene catalyst system to propylene. The propylene may then be prepolymerized in a loop reactor 62 with a short residence time. Thereafter, the metallocene catalyst system, as described in more detail below, may then be introduced to the catalyst system input line 25. The catalyst system input line 25 may then introduce the metallocene catalyst system to the loop reactor 15. The propylene supply line 20 may introduce the propylene to the loop reactor 15. The metallocene catalyst system and propylene mixture may comprise the polymerization reaction mass. The impeller 30 may circulate the polymerization reaction mass. The polypropylene product may comprise a metallocene catalyzed isotactic polypropylene (“m-iPP”). The m-iPP product of the loop reactor 5 may exit the loop reactor 5 and may be introduced to the film processing unit 10, whereby the m-iPP may be processed into the film product. Alternatively, the m-iPP product exiting the loop reactor may be combined with optional additives, extruded into granules or pellets, and sold to film producers who feed the granules to a film processing unit.

In alternative embodiments, the m-iPP may be treated with additives. The additives may be added to the reactor system 5 during the polymerization. Alternatively, the additives may be added to the m-iPP after polymerization. The additives may comprise less than about 4.0 weight percent of the m-iPP. The use of additives for polymers is well known in the art. Suitable additives may include but are not limited to antioxidants, process stabilizers, light stabilizers, acid scavengers, lubricants, processing aids, anti-blocking additives, slip additives, antifogging additives, antistatic additives, flame retardants, nucleating agents, fillers, pigments and antimicrobial agents.

### II. METALLOCENE CATALYST LOADING AND SUPPORTS

Catalyst systems useful in the formation of isotactic polyolefins include the racemic bis-indenyl compounds of the type disclosed in U.S. Pat. No. 4,794,096 to Ewen. The bis(indenyl) ligand structures may be unsubstituted or they may be substituted as described below. Examples of bis(indenyl) type catalysts that can be used include: rac-dimethylsilylanediylbis(2-methyl-4-phenyl-1-indenyl)zirconium dichloride and rac-dimethylsilylanediylbis (2-methyl-1-indenyl)zirconium dichloride.

Other isospecific metallocenes useful in carrying out the invention can be based upon cyclopentadienyl fluorenyl ligand configurations which are substituted to provide a lack of bilateral symmetry. Catalysts of this nature are disclosed in U.S. Pat. No. 5,416,228 to Ewen et al. Here, the ligand structure is configured so that one cyclopentadienyl group of a bridged ligand has a bulky group on one and only one of the distal positions of a cyclopentadienyl ring. Typical of such metallocenes is isopropylidene (3-tertiary butyl cyclopentadienyl fluorenyl) zirconium dichloride.

Other isospecific metallocenes that can be used in the present invention are based on cyclopentadienyl fluorenyl ligand structures as disclosed in U.S. Pat. No. 6,559,089 to Razavi et al. The ligand structures are characterized by bridged cyclopentadienyl and fluorenyl groups in which the cyclopentadienyl group is substituted at both proximal and distal positions. The distal substituent is desirably a bulky group such as a tertiary butyl group, and the proximal substituent is desirably a less bulky group such as a methyl group which may be either vicinal or non-vicinal to the distal substituent. The fluorenyl group may be substituted or unsubstituted with up to eight substituent groups but desirably is unsubstituted at the positions which are distal to the bridgehead carbon atom. Specifically disclosed in U.S. Pat. No. 6,559,089 are isopropylidene(3-tertiary butyl, 5-methyl cyclopentadienyl fluorenyl) zirconium dichloride and isopropylidene(3-tertiary butyl, 2-methyl cyclopentadienyl fluorenyl) zirconium dichloride.

Yet other isospecific metallocenes based upon bis(fluorenyl) ligand structures are disclosed in U.S. Pat. No. 5,945,365 to Reddy. Here, the ligand structure is characterized by two bridged fluorenyl groups with 1 or 2 substituents at distal positions on each fluorenyl group with one group of substituents being located transversely from the other with respect to a plane of bilateral symmetry extending through the bridge group. Desirable ligand structures are bridged bisfluorenyl ligands substituted at the 4,4′ positions by methyl, methoxy, isopropyl or tertiary butyl groups. For a further description of isospecific metallocenes, reference is made to the aforementioned U.S. Pat. 4,794,096, 5,416,228 and 5,945,365 and 6,559,089, the entire disclosures of which are incorporated herein by reference.

Catalysts that produce isotactic polyolefins are disclosed in U.S. Pat. Nos. 4,794,096 and 4,975,403 to Ewen. These patents disclose stereorigid metallocene catalysts that polymerize olefins to form isotactic polymers and are especially useful in the polymerization of highly isotactic polypropylene. As disclosed, for example, in the aforementioned U.S. Pat. No. 4,794,096, stereorigidity in a metallocene ligand is imparted by means of a structural bridge extending between cyclopentadienyl groups. Specifically disclosed in this patent are stereoregular hafnium metallocenes that may be characterized by the following formula:
R″(C₅(R′)₄)₂HfQₚ (5)

In Formula (5), (C₅(R′)₄) is a cyclopentadienyl or substituted cyclopentadienyl group, R′ is independently hydrogen or a hydrocarbyl radical having 1-20 carbon atoms, and R″ is a structural bridge extending between the cyclopentadienyl rings. Q is a halogen or a hydrocarbon radical, such as an alkyl, aryl, alkenyl, alkylaryl, or arylalkyl, having 1-20 carbon atoms, and p is 2.

### III. THE M-IPP

The metallocene polypropylene product of loop reactor 5 may comprise a generally isotactic stereoregularity (m-iPP). Alternatively, the polypropylene product may comprise a generally syndiotactic stereoregularity (m-sPP). The isotacticity of the polypropylene product may be measured in terms of the percentage content of meso configurations in an amount of polypropylene product. For instance, the isotacticity of the m-iPP may have an isotacticity of less than about 99.0 percent by weight of the m-iPP. Alternatively, the m-iPP may have an isotacticity of less than about 95.0 percent by weight of the m-iPP. Further alternatives comprise the m-iPP having less than about 90.0 percent isotacticity by weight of the m-iPP. The m-iPP may also comprise a regioregularity having 1,2 insertions and 2,1 insertions, which are represented in terms of insertion errors. The insertion errors may be measured in terms of the percent occurrence of the 2,1 insertions in relation to the 1,2 insertions. For instance, the m-iPP may have insertion errors of more than about 5.0 percent by weight of the m-iPP. Alternatively, the m-iPP may have insertion errors of more than about 2.0 percent by weight of the m-iPP. Further alternatives comprise the m-iPP having insertion errors of less than about 0.5 percent by weight of the m-iPP. Other properties of the m-iPP comprise a melting temperature of from about 125° C to about 165° C. In addition, the m-iPP may have a melt flow rate (“MFR”) of from about 2.0 dg/min to about 10.0 dg/min, as measured per ASTM D1238 “L”. Further properties include the m-iPP having a molecular weight distribution (“MWD”) of from about 2.0 to about 7.0.

### VII. PRODUCTION OF THE FILM PRODUCT AND SLIT TAPES

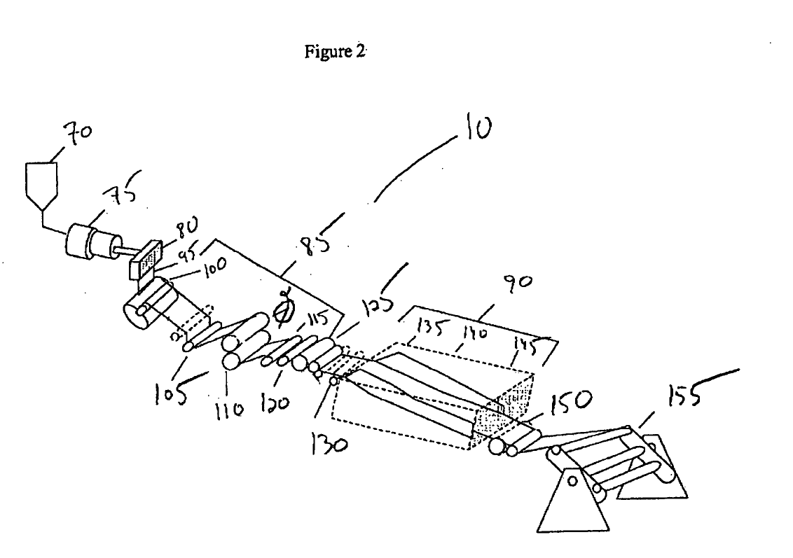

Processing polypropylene into a film product that may be slit into tape is well known in the art. In an embodiment shown in FIG. 2, a “Bouligny Slit Tape” line is used to make slit tape. The film processing unit 10 may comprise the hopper 70, the extruder 75, the slot die 80, a quench bath 160, one or more slitter blades 165, and the lateral stretching section 90.

The following describes an exemplary application of the embodiment as illustrated on FIG. 2. The polypropylene may be supplied to the hopper 70 and stored therein. From the hopper 70, the polypropylene may be directed to the extruder 75, where sufficient heat may be applied to melt the polypropylene. The extruder 75 may comprise a temperature profile of about 196 degrees centigrade/207 degrees centigrade/218 degrees centigrade/229 degrees centigrade/242 degrees centigrade/252 degrees centigrade. Alternatively, the extruder 75 may be operated at a temperature profile higher or lower than such temperature profile depending on varying conditions such as the amount of polypropylene, the composition of polypropylene, the desired product properties and the like. From the extruder 75, the polypropylene may be directed to the slot die 80, wherein the polypropylene may be shaped into a flat film. The flat film may then be directed to the quench bath 160, wherein the flat film may be cooled to a temperature of about 37 degrees centigrade. The film processing unit 10 may further comprise at least one slitter blade 165, which may slit the film product to produce slit tape. The at least one slitter blade 165, and desirably a plurality of slitting blades, may be disposed in the film processing unit 10 after the quench bath 160. However, the at least one slitter blade may be disposed at any other position in the film processing unit 10 that may be suitable for producing the slit tape. Rollers 168 may take the cooled slit tape from the at least one slitter blade 165 or the quench bath 160 at a speed of about 100 feet per nilnute. A plurality of rollers 170 may then direct the cooled slit tape to the lateral stretching section 90 also at a speed of about 100 feet per minute. The plurality of rollers 170 may apply stretching forces to the cooled slit tape.

In the lateral stretching section 90 of FIG. 2, the preheat section 135 may heat the slit tape in an oven of about 190 degrees centigrade. From the preheat section 135, the slit tape may be directed to the drawing section 140. The slit tape may be drawn at a draw ratio of about 9.25:1. Alternatively, the slit tape may be drawn at a draw ratio of from about 8.0:1 to about 10.0:1. In other alternatives, the slit tape may be drawn at a draw ratio of from about 5.0:1 to about 12.0:1. The slit tape may then be directed to the annealing section 145, wherein the slit tape may be heated to a temperature of about 165 degrees centigrade. Alternatively, the slit tape may be heated to a temperature of from about 130 degrees centigrade to about 170 degrees centigrade. The slit tape may then be withdrawn from the lateral stretching section 90 as the slit tape product and may then be directed by the plurality of rollers 170 to a number of collection spools (not illustrated) for storage. The collection spools may comprise any suitable equipment that may be disposed to store the slit tape product. The slit tape may comprise substantially similar properties as the film product. For instance, the slit tape may comprise a tenacity of about 5.0 g/den. Alternatively, the tenacity may be at least about 2.5 g/den.

In an alternative embodiment shown in FIG. 3, a biaxially-oriented film processing unit 10 is used to make film that is slit into tape. The film processing unit 10, for example a “Tenter Frame” orientation process, may produce a biaxially-oriented polypropylene film product. The film processing unit 10 may comprise an extruder 75, a slot die 80, a transverse stretching section 85, and a lateral stretching section 90.

The following describes an exemplary application of the embodiment as illustrated on FIG. 3. After leaving the reactor, the polymer typically is purified, dried, additivated, and pelletized. It may also be pellet blended with colorants, process aids, fillers, etc common to the art. The polypropylene may then be supplied from a hopper 70 to the extruder 75. The extruder 75 may comprise any suitable extruder that may be sufficient to extrude the polypropylene within the operating conditions of the Tenter Frame process. The extruder 75 may comprise a temperature profile sufficient to provide a polymer melt temperature of from about 200-260 deg C. Alternatively, the extruder 75 may be operated at a temperature profile higher or lower than such temperature profile depending on varying conditions such as the amount of polypropylene, the composition of polypropylene, and the like. The molten polypropylene may then be directed to the slot die 80, wherein the polypropylene may be shaped into a flat film 95. The flat film 95 may then be applied to a chill roller 100, whereby the flat film 95 may be cooled to a temperature of from about 30 degrees centigrade to about 60 degrees centigrade. From the chill roller 100, the cooled flat film 95 may be introduced to the stretching section 85, wherein at least one idle roller 105 may direct the chilled flat film 95 to at least one preheat roller 110. The idle roller 105 and at least one preheat roller 110 may stretch the chilled flat film 95. The at least one preheat roller 110 may apply heat to the flat film 95 and thereby increase the temperature of the flat film 95 by from about 60 degrees centigrade to about 100 degrees centigrade. From the at least one preheat roller 110, the heated flat film 95 may be directed to a slow roller 115. The slow roller 115 may be operated at a speed of from about 10 feet per minute to about 40 feet per minute. From the slow roller 115, the flat film 95 may be applied to a fast roller 120, whereby the fast roller 120 may be operated at a speed of about 150 feet per minute to provide a surface speed at the circumference of the fast roller 120 of from about 5 to about 10 times that of the slow roller 115. The slow roller 115 and fast roller 120 may further stretch the flat film 95. The flat film 95 may then be introduced to an orientation roller 125 at room temperature. From the orientation roller 125, an at least one idle roller 130 may direct the flat film 95 to the lateral stretching section 90.

In the lateral stretching section 90 of FIG. 3, the flat film 95 may be oriented by applying force to stretch the flat film 95 in a substantially transverse direction. The lateral stretching section 90 may comprise at least one tandem heating roller (not illustrated), a preheat section 135, a drawing section 140, and an annealing section 145. The at least one tandem heating roller may direct the flat film 95 to the preheat section 135, wherein the flat film 95 may be heated to a temperature of from about 130 degrees centigrade to about 180 degrees centigrade. From the preheat section 135, the flat film 95 may be directed to the drawing section 140. The drawing section 140 may comprise at least one attachment device that may be secured to opposing sides of the flat film 95 and thereby may provide a lateral force to the opposing sides of the flat film 95. The attachment device may comprise a tenter clip or any other suitable attachment device. The flat film 95 may be stretched at lateral stretching ratios comprising from about 8.0:1 to about 12.0:1, which is a measurement in relation to the original width of the flat film 95. Alternatively, the lateral stretching ratios may be from about 5.0:1 to about 10.0:1. The flat film 95 may then be directed to the annealing section 145, wherein the flat film 95 may be heated to a temperature of from about 130 degrees centigrade to about 170 degrees centigrade. The annealing section 145 may comprise an oven or any other suitable device for heating the flat film 95. The flat film 95 may be heated in the annealing section 145 for a period of time of from about 1 second to about 10 seconds. The flat film 95 may then be withdrawn from the lateral stretching section 90 as the film product and may be directed to a chill roller 150. The chill roller 150 may be configured to reduce the temperature of the film product to less than about 50 degrees centigrade. The film product may then be directed by take-up spools 155 to collection spools (not illustrated) for storage. The film processing unit 10 may further comprise at least one slitter blade (not illustrated), which may slit the film product to produce a slit tape as described previously. The slitter blade may comprise any slitting device suitable for slitting the film product into a slit tape. The at least one slitter blade may be disposed in the film processing unit 10 after the lateral stretching section 90. However, the at least one slitter blade may be disposed at any other position in the film processing unit 10 that may be suitable for producing the slit tape. The slit tape may be produced at any suitable width. The foregoing is a description of an exemplary application for manufacturing the film product, and the invention is not limited to such foregoing description. For instance, the film processing unit 10 may not be limited to the disclosed equipment and steps but may include the equipment and steps in varying order and with varying operating conditions. Further, the film processing unit 10 may comprise any additional equipment that may be known to one in the art that may produce the film product. Moreover, the film processing unit 10 may operate sufficiently with less than all of the disclosed equipment and steps in producing the film product.

### VIII. PRODUCTION OF THE WOVEN FABRIC

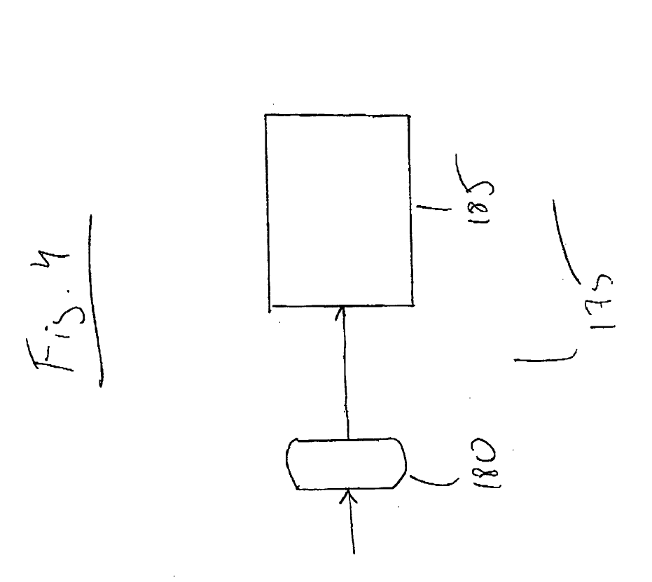

FIG. 4 illustrates an overview of a weaving process 175 for producing a woven fabric from the slit tape. The weaving process 175 may comprise at least one loom beam 180. In addition, the weaving process 175 may comprise at least one loom 185. The loom beam 180 supplies the loom 185 with a purality of warp yarns (not illustrated) and at least one shuttle (not illustrated). The weaving process is well known in the art and may include any suitable loom beam and loom that may produce a woven fabric.

The following describes an exemplary illustrative embodiment of the weaving process 175 depicted in FIG. 4. As depicted in FIG. 4, the slit tapes may be directed to the loom beam 180, wherein the slit tape may be stored. The loom beam 180 may be disposed to supply from about 100 to about 3,000 slit tape warp yarns to the loom 185. Alternatively, the loom beam 180 may supply more or less slit tape warp yarns depending upon the width of the loom beam 180, the width of the slit tape, the desired closeness of the woven product, and like factors. The plurality of fill yarns may be disposed to run in a substantially cross-machine direction. The plurality of fill yarns may be disposed on the outside of the loom 185 in a package (not illustrated). Alternatively, the plurality of fill yarns may be disposed on the inside of the loom 185 in a package. The package may comprise any suitable application or container that may be disposed to store the plurality of fill yarns in the weaving process 175. The plurality of fill yarns may be fed to the loom 185 from the package by a shuttle (not illustrated). Shuttles are well known in the art and may comprise any suitable device for feeding the fill yarns. The shuttle may be disposed to pass the plurality of fill yarns substantially across the loom 185. The plurality of fill yarns may then be cut, and the shuttle may then pass substantially back across the loom 185 to repeat the process. The plurality of fill yarns may then be woven with the slit tape to produce the desired woven product. The woven fabric may comprise monofilaments, strapping, netting, and the like.

### IX. EXAMPLES

To further illustrate various illustrative embodiments of the present invention, the following examples are provided.

### Example 1

In this example, m-iPP and zn-iPP polymers were produced, and the stereoregularity and regioregularity of these polymers were compared. TABLE 1 illustrates the stereoregularity and regioregularity of the m-iPP over the Ziegler-Natta catalyzed polypropylene (“zn-iPP”). In this example, the stereoregularity in terms of isotacticity and regioregularity in terms of the insertion errors of the m-iPP and zn-iPP were measured by Nuclear Magnetic Resonance (“NMR”). Table 1 represents the average resulting isotacticity and insertion errors of such measurements. As shown in TABLE 1, the m-iPP measurements indicate about a 15 percent lower isotacticity than the zn-iPP measurements. In addition, the insertion errors may be more than twice as prevalent in the m-iPP measurements than in the zn-iPP measurements. Consequently, such higher levels of chain deformities may result in a m-iPP film product that produces a stronger woven product than a woven product produced from the zn-iPP film product.

TABLE 1

| Properties | m-iPP | Zn-iPP |
|---|---|---|
| Isotacticity (mmm) | <80 | 90-97 |
| Insertion Errors (measured | >50 | <20 |
| per 1000 carbons) | | |

### Example 2

In this example, m-iPP and zn-iPP polymers were produced, and slit tapes were then produced from film products made of these polymers. For the production of the m-iPP and the zn-iPP polymers, a propylene monomer was polymerized by methods typical to the art. In addition, a similar additive package was added to both the m-iPP and the zn-iPP prior to pellitization.

Table 2 represents MFR and MWD values typical of the polymers referred to in this example. As illustrated in TABLE 2, the m-iPP polymer exhibited an average MFR and MWD lower than did the zn-iPP polymer.

TABLE 2

| Polymer Characteristic | m-iPP | Zn-iPP |
|---|---|---|
| MFR, g/10 min | 2.5 | 3.5 |
| MWD (pellet) | 2.5-4.0 | 4.2-5.0 |

TABLE 3 represents average properties of each slit tape made from the film products that were produced from the m-iPP and zn-iPP polymers. The polymers were processed at the limits of their drawability at their respective run conditions, that is they processed with an acceptable and similar level of draw breaks. The draw ratios used for the miPP and the zniPP were each close to the maximum. These average properties were determined by taking 5-10 measurements of each property using the procedures set forth previously.

TABLE 3

| Slit Tape Property | m-iPP | zn-iPP |
|---|---|---|
| Draw Ratio | 9.25 | 6.9 |
| Tape Denier, g/9000 m | 2500 | 2400 |
| Tape Elongation at peak, % | 13 | 46 |
| Modulus, g/den | 46 | 23 |
| Tape Tenacity at peak before | 5.0 | 4.3 |
| Weaving, g/den | | |
| Tape Tenacity at peak after | 4.8 | 2.5 |
| Weaving, g/den | | |

As TABLE 3 illustrates, the m-iPP and zn-iPP slit tapes had similar deniers. However, the m-iPP slit tape exhibited a higher modulus and lower tape elongation than the zn-iPP slit tape. As further illustrated, the m-iPP tapes exhibited maximum tenacity at a draw ratio higher than the zn-PP tapes. As further illustrated, the m-iPP slit tape exhibited about a 16 percent higher tape tenacity, before weaving, than the zn-iPP slit tape. In addition, the m-iPP slit tape exhibited about a 4 percent drop in tape tenacity after weaving (tape unwoven and removed for measurement), and the zn-iPP slit tape exhibited about a 42 percent drop in tape tenacity after weaving. From the results shown in TABLES 2 and 3, the m-iPP slit tapes have a higher strength than the zn-iPP slit tapes, both before and after weaving. In addition, the m-iPP slit tapes may withstand the stresses of weaving better than the zn-iPP slit tapes. Therefore, to produce a woven product with substantially similar toughness and strength properties, the m-iPP woven product may comprise less polymer than the zn-iPP produced woven product.

### Examples 3-14

EXAMPLES 3-8 illustrate m-iPP slit tapes produced at varying draw ratios, and EXAMPLES 9-14 illustrate zn-iPP slit tapes produced at varying draw ratios. The m-iPP polymer used to produce the m-iPP slit tape exhibited a MFR of 4.0 g/10 minutes. The zn-iPP polymer used to produce the zn-iPP slit tape exhibited a MFR of 3.8 g/10 minutes.

The slit tapes were prepared from the m-iPP and zn-iPP polymers on a conventional Bouligny Tape Line having an extruder setting with temperature settings of about 200-210-220-230-240-250 C. In addition, the Bouligny Tape Line comprised a quench tank operating at about 27 degrees centigrade. The take away speed from the quench tank was a speed of at about 100 feet per minute. The film (or tapes) was heated in an oven set at about 200 C. In the drawing section, the film product was drawn at a draw ratio of about 5.0:1 to about 8.0:1. The drawn film product was annealed in the annealing section, which was run at a set temperature of about 160° C. The slit tapes illustrated in EXAMPLES 3-14 exhibited a denier of about 1000 grams/9000 meters. Various properties of the slit tapes produced at the varying draw ratios were measured, and the results are illustrated on TABLE 4, wherein Examples 3-8 are m-iPP and Examples 9-14 are zn-iPP.

TABLE 4

| | Example | | | | | | | | | | | |
|---|---|---|---|---|---|---|---|---|---|---|---|---|
| | 3 | 4 | 5 | 6 | 7 | 8 | 9 | 10 | 11 | 12 | 13 | 14 |
| Draw Ratio | 5:1 | 6:1 | 6.5:1 | 7:1 | 7.5:1 | 8:1 | 5:1 | 6:1 | 6.5:1 | 7:1 | 7.5:1 | 8:1 |
| Modulus at | 15.5 | 23.2 | 26.7 | 31.2 | 33.5 | 36.5 | 22.3 | 30.2 | 34.1 | 36.9 | 39.2 | 34.1 |
| 5% elongation, | | | | | | | | | | | | |
| g/den | | | | | | | | | | | | |
| Tenacity at | 0.9 | 1.3 | 1.4 | 1.6 | 1.7 | 1.9 | 1.2 | 1.5 | 1.7 | 1.9 | 2.0 | 1.7 |
| 5% elongation, | | | | | | | | | | | | |
| g/den | | | | | | | | | | | | |
| Tenacity at | 4.9 | 6.2 | 7.1 | 7.3 | 6.6 | 5.4 | 5.7 | 7.1 | 7.2 | 5.9 | 5.2 | 4.3 |
| maximum, | | | | | | | | | | | | |
| g/den | | | | | | | | | | | | |
| Tenacity at | 4.4 | 5.6 | 6.4 | 6.5 | 6.0 | 4.9 | 5.2 | 6.4 | 6.5 | 5.3 | 4.6 | 3.9 |
| Break, g/den | | | | | | | | | | | | |
| Elongation at | 47.6 | 35.6 | 33.3 | 29.1 | 22.7 | 16.1 | 43.5 | 34.3 | 27.8 | 20.1 | 14.3 | 13.5 |
| Maximum, % | | | | | | | | | | | | |
| Elongation at | 48.5 | 36.8 | 33.6 | 29.8 | 26.0 | 20.5 | 44.6 | 34.6 | 28.8 | 22.0 | 16.9 | 15.0 |
| Break, % | | | | | | | | | | | | |
| Shrinkage | 5.6 | 14.4 | 17.1 | 17.7 | 17.6 | 18.1 | 3.7 | 6.5 | 6.6 | 7.5 | 7.6 | 5.7 |
| @132 | | | | | | | | | | | | |
| degrees C., % | | | | | | | | | | | | |

From the results in TABLE 4, the m-iPP tapes exhibited statistically equal or better tenacity at draw ratios of 6.5:1 and higher, and better elongation at all draw ratios explored, that is at the same tenacity the m-iPP tapes display much improved elongation.

It will be understood that the present invention is not limited to the Tenter Frame and Bouligny Slit Tape processes but may comprise any suitable process for the production of the film product and slit tape. Moreover, the present invention is not limited to the loom in producing a woven product but may comprise any suitable process for the production of a woven product from a film product or slit tape. Although the present invention and its advantages have been described in detail, it should be understood that various changes, substitutions and alterations may be made herein without departing from the spirit and scope of the invention as defined by the appended claims.

1. A film product comprising:
a metallocene catalyzed polypropylene; and
a tenacity of at least about 2.5 g/den,
wherein the film product is capable of being drawn at a draw ratio of from about 5.0:1 to about 10.0:1.

2. The film product of claim 1, wherein the film product further comprises a tenacity of about 5.0 g/den.

3. The film product of claim 2, wherein the film product is capable of being processed into at least one of a slit tape and a woven product, wherein the tenacity of the woven product is about 4.8 g/den.

4. The film product of claim 1, wherein the draw ratio is about 9.25:1.

5. The film product of claim 1, wherein the metallocene catalyzed polypropylene comprises at least one additive.

6. The film product of claim 1, wherein the film product is capable of being processed into a slit tape product.

7. The film product of claim 6, wherein at least one of the film product and the slit tape product are capable of being woven into a woven product.

8. The film product of claim 7, wherein the woven product comprises a tenacity of within about 10.0 percent of the tenacity of the at least one of the film product and the slit tape product.

9. The film product of claim 1, wherein the metallocene catalyzed polypropylene comprises a metallocene catalyzed isotactic polypropylene.

10. The film product of claim 9, wherein the metallocene catalyzed isotactic polypropylene comprises an isotacticity of less than about 99.0 percent.

11. The film product of claim 9, wherein the metallocene catalyzed isotactic polypropylene comprises an insertion error of more than about 2.0 percent.

12. The film product of claim 1, wherein the metallocene catalyzed polypropylene comprises a polymerized propylene.

13. A film product of a process comprising:
(A) polymerizing a monomer in the presence of a metallocene catalyst system to produce metallocene catalyzed polypropylene, wherein the metallocene catalyst system comprises a metallocene catalyst;
(B) processing the metallocene catalyzed polypropylene into a film product; and
(C) drawing the film product at a draw ratio of from about 5.0:1 to about 10.0:1, the film product comprising a tenacity of at least about 2.5 g/den.

14. The film product of claim 13, wherein the monomer comprises a propylene.

15. The film product of claim 13, wherein the metallocene catalyst system comprises a co-catalyst.

16. The film product of claim 13, wherein the co-catalyst comprises an organoaluminum compound.

17. The film product of claim 13, wherein the metallocene catalyst system comprises at least one of a homogenous catalyst system and a supported catalyst system.

18. The film product of claim 13, wherein said polymerizing the monomer is performed in a loop reactor system.

19. The film product of claim 13, wherein said process further comprises
(i) extruding the metallocene catalyzed polypropylene; and
(ii) drawing the metallocene catalyzed polypropylene through a die.

20. The film product of claim 13, wherein said polymerizing the monomer further comprises adding at least one additive.

21. The film product of claim 13, wherein the process further comprises
(i) processing the film product into a slit tape product, the processing comprising slitting the film product.

22. The film product of claim 21, wherein the process further comprises
(i) weaving the slit tape product into a fabric.

23. The film product of claim 22, wherein the fabric comprises a tenacity of within about 10.0 percent of the tenacity of the film product.

24. The film product of claim 13, wherein the process further comprises
(i) weaving the film product into a fabric.

25. The film product of claim 24, wherein the fabric comprises a tenacity of within about 10.0 percent of the tenacity of the film product.

26. The film product of claim 13, wherein the metallocene catalyzed polypropylene further comprises a metallocene catalyzed isotactic polypropylene.

27. The film product of claim 13, wherein the film product comprises an isotacticity of less than about 99.0 percent.

28. A method of producing a metallocene catalyzed polypropylene film product having a tenacity of at least about 2.5 g/den, the method comprising:
(A) extruding a metallocene catalyzed polypropylene;
(B) forming the metallocene catalyzed polypropylene into a substantially flat product;
(C) cooling the substantially flat product; and
(D) stretching the substantially flat product into the metallocene catalyzed polypropylene film product.

29. The method of claim 28, wherein said formation further comprises using a die to form the substantially flat product.

30. The method of claim 28, wherein said cooling further comprises cooling the substantially flat product with cooling equipment, the cooling equipment selected from the group consisting of:
(i) at least one chill roller; and
(ii) at least one quench bath.

31. The method of claim 30, wherein the at least one chill roller cools the substantially flat product to a temperature of from about 30 degrees centigrade to about 60 degrees centigrade.

32. The method of claim 28, wherein said stretching further comprises:
(i) heating the substantially flat product;
(ii) drawing the substantially flat product; and
(iii) annealing the substantially flat product.

33. The method of claim 32, wherein said heating further comprises heating the substantially flat product to a temperature of from about 130 degrees centigrade to about 180 degrees centigrade.

34. The method of claim 32, wherein said drawing further comprises drawing the substantially flat product at a draw ratio of from about 5.0:1 to about 10.0:1.

35. The method of claim 32, wherein said drawing further comprises drawing the substantially flat product at a draw ratio of about 9.25:1.

36. The method of claim 32, wherein said annealing further comprises heating the substantially flat product to a temperature of from about 130 degrees centigrade to about 170 degrees centigrade.

37. The method of claim 28, further comprising
(i) processing the film product into a slit tape product.

38. The method of claim 37, further comprising
(i) weaving the slit tape product into a woven product.

39. The method of claim 38, wherein the woven product comprises a tenacity of within about 10.0 percent of the tenacity of the film product.

40. The method of claim 28, further comprising
(i) weaving the film product into a woven product.

41. The method of claim 40, wherein the woven product comprises a tenacity of within about 10.0 percent of the tenacity of the film product.

42. A method of weaving a woven product from a slit tape having a tenacity of at least about 2.5 g/den, wherein the slit tape comprises a processed metallocene catalyzed polypropylene film product, the method comprising:
(A) supplying the slit tape to a loom, the slit tape being configured to be stored in a loom beam; and
(B) weaving the slit tape into the woven product, the woven product having a tenacity of within about 10.0 percent of the tenacity of the slit tape.

43. The method of claim 42, wherein said weaving further comprises weaving a plurality of fill yarns into the woven product.

44. The method of claim 42, wherein the woven product has a tenacity of within about 10.0 percent of the tenacity of the metallocene catalyzed polypropylene film product.
